(19) United States
(12) Patent Application Publication
(10) Pub. No.: US 2026/0143266 A1
(43) Pub. Date: May 21, 2026

(54) SYSTEMS AND METHODS FOR MANUFACTURING CURVED SPEAKER GRILLE

(71) Applicant: SONOS, INC., Goleta, CA (US)

(72) Inventors: Nicolas Morgan JONES, Santa Barbara, CA (US); Ronald W. ROBERTS, Melrose, MA (US); Patrick CAIN, Boston, MA (US); Eduardo SALAZAR, Oxnard, CA (US); Philippe VOSSEL, Wuppertal (DE); Simby CAMRAL, Shanghai (CN); Qiang WU, Zhuhai (CN)

(21) Appl. No.: 19/114,933

(22) PCT Filed: Sep. 30, 2022
(86) PCT No.: PCT/CN2022/123296

§ 371 Date: Mar. 25, 2025

(51) Int. Cl. H04R 1/02

(52) U.S. Cl. CPC H04R 1/023; H04R 1/025; H04R 2201/029; H04R 2400/11

(57) ABSTRACT

A method for mounting a flexible speaker grille onto an audio speaker housing is provided, the method comprises: mounting two plastic frame members to a speaker housing by one or more screws into threaded holes in the speaker housing; applying adhesive to the outer surface of each of the two frame members; aligning one or more locating pins of a grille subassembly to corresponding one or more receiving holes a speaker housing, wherein the grille subassembly comprises: a grille surface comprising a thin, flat piece of plastic having holes through it; strips of one side of a hook-and-loop fastener attached across each of the four edges of the grille surface; the one or more locating pins near the midpoint of one of the long edges of the grille surface; wrapping the grille subassembly around the speaker housing such that the grille subassembly conforms to the adjacent surface of the speaker subassembly to speaker housing and attaching the strips of hook-and-loop faster to a complementary side of hook-and-loop fastener located on the speaker housing; and attaching each distant edge of the grille subassembly to the adhesive on the outer surface of each of the two frame members.

### FIELD OF THE DISCLOSURE

The disclosure is related to consumer goods and, more particularly, to methods, systems, products, features, services, and other elements directed to manufacturing media playback devices or some aspect thereof.

### BACKGROUND

Options for accessing and listening to digital audio in an out-loud setting were limited until in 2003, when SONOS, Inc. filed for one of its first patent applications, entitled “Method for Synchronizing Audio Playback between Multiple Networked Devices,” and began offering a media playback system for sale in 2005. The Sonos Wireless HiFi System enables people to experience music from many sources via one or more networked playback devices. Through a software control application installed on a smartphone, tablet, or computer, one can play what he or she wants in any room that has a networked playback device. Additionally, using the controller, for example, different songs can be streamed to each room with a playback device, rooms can be grouped together for synchronous playback, or the same song can be heard in all rooms synchronously.

Given the ever growing interest in digital media, there continues to be a need to develop consumer-accessible technologies to further enhance the listening experience.

### BRIEF DESCRIPTION OF THE DRAWINGS

Features, aspects, and advantages of the presently disclosed technology may be better understood with regard to the following description, appended claims, and accompanying drawings where:

FIG. 1 shows an example media playback system configuration in which certain embodiments may be practiced;

FIG. 2 shows a functional block diagram of an example playback device;

FIG. 3 shows a functional block diagram of an example control device;

FIG. 4 shows an example controller interface;

FIGS. 5A and 5B show frame members and a speaker housing in accordance with an embodiment of the invention;

FIG. 6 shows adhesive applied to frame members in accordance with an embodiment of the invention;

FIGS. 7A, 7B, and 7C show a grille subassembly in accordance with an embodiment of the invention;

FIGS. 8A and 8B show hook-and-loop fasteners on a speaker housing in accordance with an embodiment of the invention;

FIGS. 9A and 9B show alignment of a grille subassembly with a speaker housing in accordance with an embodiment of the invention;

FIGS. 10A, 10B, and 10C show a grille subassembly fastened to frame members by adhesive in accordance with an embodiment of the invention;

FIG. 11 is a flow chart showing a process for manufacturing a curved speaker grille on a speaker housing in accordance with an embodiment of the invention;

The drawings are for the purpose of illustrating example embodiments, but it is understood that the inventions are not limited to the arrangements and instrumentality shown in the drawings.

### DETAILED DESCRIPTION

### I. Overview

Some embodiments described herein involve installing a curved speaker grille on a speaker housing of a playback device having a partially curved industrial design. In some cases, the curvature(s) of the playback device may be axially variable along the speaker housing. The speaker grille can have small openings to allow air and sound waves to pass through while offering aesthetic and protective covering of speaker transducers and/or other components of the playback device. In some embodiments, a grille assembly may include one or more frame members, a grille surface, one or more locating pins, and one or more fasteners. In some cases, the grille assembly may initially be flat, and wrapped to conform to the curvature of the speaker housing while the frame members and fasteners align and secure it to the speaker housing. In some other cases, the grille assembly may be pre-curved to at least partially match the curvature(s) of the speaker housing.

In one example, the frame members may be attached to the speaker housing using removable screws, and the fasteners are configured to be detachable and re-attachable, thereby facilitating detachment and re-attachment of the grille assembly from and to the speaker housing. The convenient removal and replacement of the grille assembly from the speaker housing may improve ease of repair and maintenance of the playback device.

In some cases, the grille assembly may be partially or wholly assembled prior to attachment to the speaker housing. In some other cases, at least some components of the grille assembly may be assembled via attachments to the speaker housing. For instance, frame members may be attached to the speaker housing, and the speaker grille may be wrapped around the speaker housing before the speaker grille is attached to the frame members to form the grille assembly. The process of assembling the grille assembly while components of the grille assembly are attached to the speaker housing may provide better alignment between the speaker grille assembly and the speaker housing.

While some examples described herein may refer to functions performed by given actors such as “users” and/or other entities, it should be understood that this is for purposes of explanation only. The claims should not be interpreted to require action by any such example actor unless explicitly required by the language of the claims themselves. It will be understood by one of ordinary skill in the art that this disclosure includes numerous other embodiments.

### II. Example Operating Environment

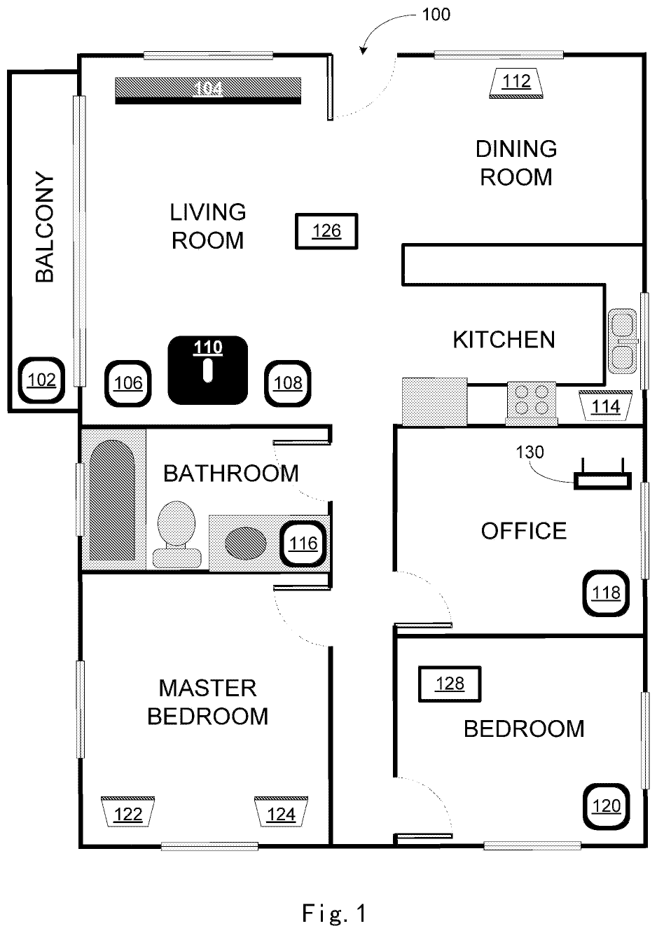

FIG. 1 shows an example configuration of a media playback system 100 in which one or more embodiments disclosed herein may be practiced or implemented. The media playback system 100 as shown is associated with an example home environment having several rooms and spaces, such as for example, a master bedroom, an office, a dining room, and a living room. As shown in the example of FIG. 1, the media playback system 100 includes playback devices 102-124, control devices 126 and 128, and a wired or wireless network router 130.

Further discussions relating to the different components of the example media playback system 100 and how the different components may interact to provide a user with a media experience may be found in the following sections. While discussions herein may generally refer to the example media playback system 100, technologies described herein are not limited to applications within, among other things, the home environment as shown in FIG. 1. For instance, the technologies described herein may be useful in environments where multi-zone audio may be desired, such as, for example, a commercial setting like a restaurant, mall or airport, a vehicle like a sports utility vehicle (SUV), bus or car, a ship or boat, an airplane, and so on.

a. Example Playback Devices

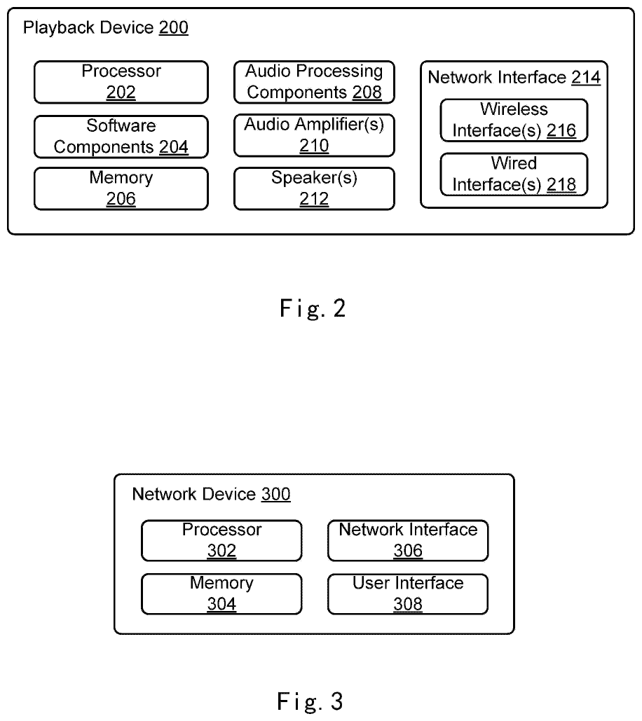

FIG. 2 shows a functional block diagram of an example playback device 200 that may be configured to be one or more of the playback devices 102-124 of the media playback system 100 of FIG. 1. The playback device 200 may include a processor 202, software components 204, memory 206, audio processing components 208, audio amplifier(s) 210, speaker(s) 212, and a network interface 214 including wireless interface(s) 216 and wired interface(s) 218. In one case, the playback device 200 may not include the speaker(s) 212, but rather a speaker interface for connecting the playback device 200 to external speakers. In another case, the playback device 200 may include neither the speaker(s) 212 nor the audio amplifier(s) 210, but rather an audio interface for connecting the playback device 200 to an external audio amplifier or audio-visual receiver.

In one example, the processor 202 may be a clock-driven computing component configured to process input data according to instructions stored in the memory 206. The memory 206 may be a tangible computer-readable medium configured to store instructions executable by the processor 202. For instance, the memory 206 may be data storage that can be loaded with one or more of the software components 204 executable by the processor 202 to achieve certain functions. In one example, the functions may involve the playback device 200 retrieving audio data from an audio source or another playback device. In another example, the functions may involve the playback device 200 sending audio data to another device or playback device on a network. In yet another example, the functions may involve pairing of the playback device 200 with one or more playback devices to create a multi-channel audio environment.

Certain functions may involve the playback device 200 synchronizing playback of audio content with one or more other playback devices. During synchronous playback, a listener will preferably not be able to perceive time-delay differences between playback of the audio content by the playback device 200 and the one or more other playback devices. U.S. Pat. No. 8,234,395 entitled, “System and method for synchronizing operations among a plurality of independently clocked digital data processing devices,” which is hereby incorporated by reference, provides in more detail some examples for audio playback synchronization among playback devices.

The memory 206 may further be configured to store data associated with the playback device 200, such as one or more zones and/or zone groups the playback device 200 is a part of, audio sources accessible by the playback device 200, or a playback queue that the playback device 200 (or some other playback device) may be associated with. The data may be stored as one or more state variables that are periodically updated and used to describe the state of the playback device 200. The memory 206 may also include the data associated with the state of the other devices of the media system, and shared from time to time among the devices so that one or more of the devices have the most recent data associated with the system. Other embodiments are also possible.

The audio processing components 208 may include one or more digital-to-analog converters (DAC), an audio preprocessing component, an audio enhancement component or a digital signal processor (DSP), and so on. In one embodiment, one or more of the audio processing components 208 may be a subcomponent of the processor 202. In one example, audio content may be processed and/or intentionally altered by the audio processing components 208 to produce audio signals. The produced audio signals may then be provided to the audio amplifier(s) 210 for amplification and playback through speaker(s) 212. Particularly, the audio amplifier(s) 210 may include devices configured to amplify audio signals to a level for driving one or more of the speakers 212. The speaker(s) 212 may include an individual transducer (e.g., a “driver”) or a complete speaker system involving an enclosure with one or more drivers. A particular driver of the speaker(s) 212 may include, for example, a subwoofer (e.g., for low frequencies), a mid-range driver (e.g., for middle frequencies), and/or a tweeter (e.g., for high frequencies). In some cases, each transducer in the one or more speakers 212 may be driven by an individual corresponding audio amplifier of the audio amplifier(s) 210. In addition to producing analog signals for playback by the playback device 200, the audio processing components 208 may be configured to process audio content to be sent to one or more other playback devices for playback.

Audio content to be processed and/or played back by the playback device 200 may be received from an external source, such as via an audio line-in input connection (e.g., an auto-detecting 3.5 mm audio line-in connection) or the network interface 214.

The network interface 214 may be configured to facilitate a data flow between the playback device 200 and one or more other devices on a data network. As such, the playback device 200 may be configured to receive audio content over the data network from one or more other playback devices in communication with the playback device 200, network devices within a local area network, or audio content sources over a wide area network such as the Internet. In one example, the audio content and other signals transmitted and received by the playback device 200 may be transmitted in the form of digital packet data containing an Internet Protocol (IP)-based source address and IP-based destination addresses. In such a case, the network interface 214 may be configured to parse the digital packet data such that the data destined for the playback device 200 is properly received and processed by the playback device 200.

As shown, the network interface 214 may include wireless interface(s) 216 and wired interface(s) 218. The wireless interface(s) 216 may provide network interface functions for the playback device 200 to wirelessly communicate with other devices (e.g., other playback device(s), speaker(s), receiver(s), network device(s), control device(s) within a data network the playback device 200 is associated with) in accordance with a communication protocol (e.g., any wireless standard including IEEE 802.11a, 802.11b, 802.11g, 802.11n, 802.11ac, 802.15, 4G mobile communication standard, and so on). The wired interface(s) 218 may provide network interface functions for the playback device 200 to communicate over a wired connection with other devices in accordance with a communication protocol (e.g., IEEE 802.3). While the network interface 214 shown in FIG. 2 includes both wireless interface(s) 216 and wired interface(s) 218, the network interface 214 may in some embodiments include only wireless interface(s) or only wired interface(s).

In one example, the playback device 200 and one other playback device may be paired to play two separate audio components of audio content. For instance, playback device 200 may be configured to play a left channel audio component, while the other playback device may be configured to play a right channel audio component, thereby producing or enhancing a stereo effect of the audio content. The paired playback devices (also referred to as “bonded playback devices”) may further play audio content in synchrony with other playback devices.

In another example, the playback device 200 may be sonically consolidated with one or more other playback devices to form a single, consolidated playback device. A consolidated playback device may be configured to process and reproduce sound differently than an unconsolidated playback device or playback devices that are paired, because a consolidated playback device may have additional speaker drivers through which audio content may be rendered. For instance, if the playback device 200 is a playback device designed to render low frequency range audio content (i.e. a subwoofer), the playback device 200 may be consolidated with a playback device designed to render full frequency range audio content. In such a case, the full frequency range playback device, when consolidated with the low frequency playback device 200, may be configured to render only the mid and high frequency components of audio content, while the low frequency range playback device 200 renders the low frequency component of the audio content. The consolidated playback device may further be paired with a single playback device or yet another consolidated playback device.

By way of illustration, SONOS, Inc. presently offers (or has offered) for sale certain playback devices including a “PLAY: 1,” “PLAY: 3,” “PLAY: 5,” “PLAYBAR,” “CONNECT: AMP,” “CONNECT,” and “SUB.” Any other past, present, and/or future playback devices may additionally or alternatively be used to implement the playback devices of example embodiments disclosed herein. Additionally, it is understood that a playback device is not limited to the example illustrated in FIG. 2 or to the SONOS product offerings. For example, a playback device may include a wired or wireless headphone. In another example, a playback device may include or interact with a docking station for personal mobile media playback devices. In yet another example, a playback device may be integral to another device or component such as a television, a lighting fixture, or some other device for indoor or outdoor use.

b. Example Playback Zone Configurations

Referring back to the media playback system 100 of FIG. 1, the environment may have one or more playback zones, each with one or more playback devices. The media playback system 100 may be established with one or more playback zones, after which one or more zones may be added, or removed to arrive at the example configuration shown in FIG. 1. Each zone may be given a name according to a different room or space such as an office, bathroom, master bedroom, bedroom, kitchen, dining room, living room, and/or balcony. In one case, a single playback zone may include multiple rooms or spaces. In another case, a single room or space may include multiple playback zones.

As shown in FIG. 1, the balcony, dining room, kitchen, bathroom, office, and bedroom zones each have one playback device, while the living room and master bedroom zones each have multiple playback devices. In the living room zone, playback devices 104, 106, 108, and 110 may be configured to play audio content in synchrony as individual playback devices, as one or more bonded playback devices, as one or more consolidated playback devices, or any combination thereof. Similarly, in the case of the master bedroom, playback devices 122 and 124 may be configured to play audio content in synchrony as individual playback devices, as a bonded playback device, or as a consolidated playback device.

In one example, one or more playback zones in the environment of FIG. 1 may each be playing different audio content. For instance, the user may be grilling in the balcony zone and listening to hip hop music being played by the playback device 102 while another user may be preparing food in the kitchen zone and listening to classical music being played by the playback device 114. In another example, a playback zone may play the same audio content in synchrony with another playback zone. For instance, the user may be in the office zone where the playback device 118 is playing the same rock music that is being playing by playback device 102 in the balcony zone. In such a case, playback devices 102 and 118 may be playing the rock music in synchrony such that the user may seamlessly (or at least substantially seamlessly) enjoy the audio content that is being played out-loud while moving between different playback zones. Synchronization among playback zones may be achieved in a manner similar to that of synchronization among playback devices, as described in previously referenced U.S. Pat. No. 8,234,395.

As suggested above, the zone configurations of the media playback system 100 may be dynamically modified, and in some embodiments, the media playback system 100 supports numerous configurations. For instance, if a user physically moves one or more playback devices to or from a zone, the media playback system 100 may be reconfigured to accommodate the change(s). For instance, if the user physically moves the playback device 102 from the balcony zone to the office zone, the office zone may now include both the playback device 118 and the playback device 102. The playback device 102 may be paired or grouped with the office zone and/or renamed if so desired via a control device such as the control devices 126 and 128. On the other hand, if the one or more playback devices are moved to a particular area in the home environment that is not already a playback zone, a new playback zone may be created for the particular area.

Further, different playback zones of the media playback system 100 may be dynamically combined into zone groups or split up into individual playback zones. For instance, the dining room zone and the kitchen zone 114 may be combined into a zone group for a dinner party such that playback devices 112 and 114 may render audio content in synchrony. On the other hand, the living room zone may be split into a television zone including playback device 104, and a listening zone including playback devices 106, 108, and 110, if the user wishes to listen to music in the living room space while another user wishes to watch television.

c. Example Control Devices

FIG. 3 shows a functional block diagram of an example control device 300 that may be configured to be one or both of the control devices 126 and 128 of the media playback system 100. As shown, the control device 300 may include a processor 302, memory 304, a network interface 306, and a user interface 308. In one example, the control device 300 may be a dedicated controller for the media playback system 100. In another example, the control device 300 may be a network device on which media playback system controller application software may be installed, such as for example, an iPhone™, iPad™ or any other smart phone, tablet or network device (e.g., a networked computer such as a PC or Mac™).

The processor 302 may be configured to perform functions relevant to facilitating user access, control, and configuration of the media playback system 100. The memory 304 may be configured to store instructions executable by the processor 302 to perform those functions. The memory 304 may also be configured to store the media playback system controller application software and other data associated with the media playback system 100 and the user.

In one example, the network interface 306 may be based on an industry standard (e.g., infrared, radio, wired standards including IEEE 802.3, wireless standards including IEEE 802.11a, 802.11b, 802.11g, 802.11n, 802.11ac, 802.15, 4G mobile communication standard, and so on). The network interface 306 may provide a means for the control device 300 to communicate with other devices in the media playback system 100. In one example, data and information (e.g., such as a state variable) may be communicated between control device 300 and other devices via the network interface 306. For instance, playback zone and zone group configurations in the media playback system 100 may be received by the control device 300 from a playback device or another network device, or transmitted by the control device 300 to another playback device or network device via the network interface 306. In some cases, the other network device may be another control device.

Playback device control commands such as volume control and audio playback control may also be communicated from the control device 300 to a playback device via the network interface 306. As suggested above, changes to configurations of the media playback system 100 may also be performed by a user using the control device 300. The configuration changes may include adding/removing one or more playback devices to/from a zone, adding/removing one or more zones to/from a zone group, forming a bonded or consolidated player, separating one or more playback devices from a bonded or consolidated player, among others. Accordingly, the control device 300 may sometimes be referred to as a controller, whether the control device 300 is a dedicated controller or a network device on which media playback system controller application software is installed.

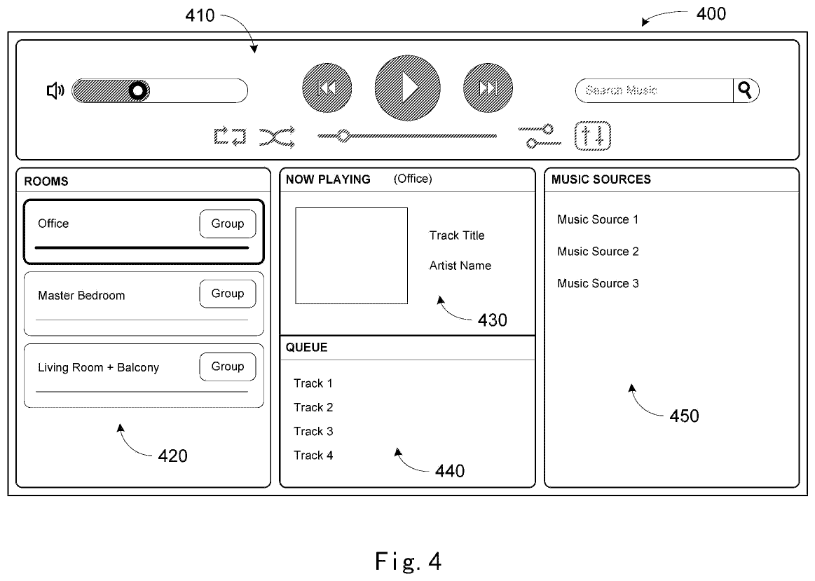

The user interface 308 of the control device 300 may be configured to facilitate user access and control of the media playback system 100, by providing a controller interface such as the controller interface 400 shown in FIG. 4. The controller interface 400 includes a playback control region 410, a playback zone region 420, a playback status region 430, a playback queue region 440, and an audio content sources region 450. The controller interface 400 as shown is just one example of a user interface that may be provided on a network device such as the control device 300 of FIG. 3 (and/or the control devices 126 and 128 of FIG. 1) and accessed by users to control a media playback system such as the media playback system 100. Other user interfaces of varying formats, styles, and interactive sequences may alternatively be implemented on one or more network devices to provide comparable control access to a media playback system.

The playback control region 410 may include selectable (e.g., by way of touch or by using a cursor) icons to cause playback devices in a selected playback zone or zone group to play or pause, fast forward, rewind, skip to next, skip to previous, enter/exit shuffle mode, enter/exit repeat mode, enter/exit cross fade mode. The playback control region 410 may also include selectable icons to modify equalization settings, and playback volume, among other possibilities.

The playback zone region 420 may include representations of playback zones within the media playback system 100. In some embodiments, the graphical representations of playback zones may be selectable to bring up additional selectable icons to manage or configure the playback zones in the media playback system, such as a creation of bonded zones, creation of zone groups, separation of zone groups, and renaming of zone groups, among other possibilities.

For example, as shown, a “group” icon may be provided within each of the graphical representations of playback zones. The “group” icon provided within a graphical representation of a particular zone may be selectable to bring up options to select one or more other zones in the media playback system to be grouped with the particular zone. Once grouped, playback devices in the zones that have been grouped with the particular zone will be configured to play audio content in synchrony with the playback device(s) in the particular zone. Analogously, a “group” icon may be provided within a graphical representation of a zone group. In this case, the “group” icon may be selectable to bring up options to deselect one or more zones in the zone group to be removed from the zone group. Other interactions and implementations for grouping and ungrouping zones via a user interface such as the controller interface 400 are also possible. The representations of playback zones in the playback zone region 420 may be dynamically updated as playback zone or zone group configurations are modified.

The playback status region 430 may include graphical representations of audio content that is presently being played, previously played, or scheduled to play next in the selected playback zone or zone group. The selected playback zone or zone group may be visually distinguished on the user interface, such as within the playback zone region 420 and/or the playback status region 430. The graphical representations may include track title, artist name, album name, album year, track length, and other relevant information that may be useful for the user to know when controlling the media playback system via the user interface 400.

The playback queue region 440 may include graphical representations of audio content in a playback queue associated with the selected playback zone or zone group. In some embodiments, each playback zone or zone group may be associated with a playback queue containing information corresponding to zero or more audio items for playback by the playback zone or zone group. For instance, each audio item in the playback queue may comprise a uniform resource identifier (URI), a uniform resource locator (URL) or some other identifier that may be used by a playback device in the playback zone or zone group to find and/or retrieve the audio item from a local audio content source or a networked audio content source, possibly for playback by the playback device.

In one example, a playlist may be added to a playback queue, in which case information corresponding to each audio item in the playlist may be added to the playback queue. In another example, audio items in a playback queue may be saved as a playlist. In a further example, a playback queue may be empty, or populated but “not in use” when the playback zone or zone group is playing continuously streaming audio content, such as Internet radio that may continue to play until otherwise stopped, rather than discrete audio items that have playback durations. In an alternative embodiment, a playback queue can include Internet radio and/or other streaming audio content items and be “in use” when the playback zone or zone group is playing those items. Other examples are also possible.

When playback zones or zone groups are “grouped” or “ungrouped,” playback queues associated with the affected playback zones or zone groups may be cleared or re-associated. For example, if a first playback zone including a first playback queue is grouped with a second playback zone including a second playback queue, the established zone group may have an associated playback queue that is initially empty, that contains audio items from the first playback queue (such as if the second playback zone was added to the first playback zone), that contains audio items from the second playback queue (such as if the first playback zone was added to the second playback zone), or a combination of audio items from both the first and second playback queues. Subsequently, if the established zone group is ungrouped, the resulting first playback zone may be re-associated with the previous first playback queue, or be associated with a new playback queue that is empty or contains audio items from the playback queue associated with the established zone group before the established zone group was ungrouped. Similarly, the resulting second playback zone may be re-associated with the previous second playback queue, or be associated with a new playback queue that is empty, or contains audio items from the playback queue associated with the established zone group before the established zone group was ungrouped. Other examples are also possible.

Referring back to the controller interface 400 of FIG. 4, the graphical representations of audio content in the playback queue region 440 may include track titles, artist names, track lengths, and other relevant information associated with the audio content in the playback queue. In one example, graphical representations of audio content may be selectable to bring up additional selectable icons to manage and/or manipulate the playback queue and/or audio content represented in the playback queue. For instance, a represented audio content may be removed from the playback queue, moved to a different position within the playback queue, or selected to be played immediately, or after any currently playing audio content, among other possibilities. A playback queue associated with a playback zone or zone group may be stored in a memory on one or more playback devices in the playback zone or zone group, on a playback device that is not in the playback zone or zone group, and/or some other designated device.

The audio content sources region 450 may include graphical representations of selectable audio content sources from which audio content may be retrieved and played by the selected playback zone or zone group. Discussions pertaining to audio content sources may be found in the following section.

d. Example Audio Content Sources

As indicated previously, one or more playback devices in a zone or zone group may be configured to retrieve for playback audio content (e.g. according to a corresponding URI or URL for the audio content) from a variety of available audio content sources. In one example, audio content may be retrieved by a playback device directly from a corresponding audio content source (e.g., a line-in connection). In another example, audio content may be provided to a playback device over a network via one or more other playback devices or network devices.

Example audio content sources may include a memory of one or more playback devices in a media playback system such as the media playback system 100 of FIG. 1, local music libraries on one or more network devices (such as a control device, a network-enabled personal computer, or a networked-attached storage (NAS), for example), streaming audio services providing audio content via the Internet (e.g., the cloud), or audio sources connected to the media playback system via a line-in input connection on a playback device or network devise, among other possibilities.

In some embodiments, audio content sources may be regularly added or removed from a media playback system such as the media playback system 100 of FIG. 1. In one example, an indexing of audio items may be performed whenever one or more audio content sources are added, removed or updated. Indexing of audio items may involve scanning for identifiable audio items in all folders/directory shared over a network accessible by playback devices in the media playback system, and generating or updating an audio content database containing metadata (e.g., title, artist, album, track length, among others) and other associated information, such as a URI or URL for each identifiable audio item found. Other examples for managing and maintaining audio content sources may also be possible.

The above discussions relating to playback devices, controller devices, playback zone configurations, and media content sources provide only some examples of operating environments within which functions and methods described below may be implemented. Other operating environments and configurations of media playback systems, playback devices, and network devices not explicitly described herein may also be applicable and suitable for implementation of the functions and methods.

### III. Manufacturing a Curved Speaker Grille Assembly

a. Grille Assembly

As discussed above, embodiments described herein involve manufacturing a curved speaker grille assembly and attaching the speaker grille assembly to the speaker housing of a playback device having a partially curved industrial design. In some cases, the curvature(s) of the playback device may be axially variable along the speaker housing. The speaker grille may be a thin, flexible material that is initially flat and becomes curved to conform to the speaker housing of a playback device as the speaker grille is attached to the speaker housing. In some cases, the speaker grille may be at least partially pre-curved to at least partially match the curvature(s) of the speaker housing. Corresponding attachment features can hold the speaker grille onto the speaker housing. In a number of embodiments, the attachment features allow for detaching the speaker grille from the speaker housing, permitting the speaker grille to be removed for maintenance, repairs, or adjustments of the playback device (e.g., to access components of the playback device that are behind the speaker grille).

A set of components or elements that includes the speaker grille and attachment features (e.g., frame members and/or fasteners) for mounting onto a speaker housing can be referred to as the grille assembly. In some examples, the grille assembly may further include a foam and/or cloth layer underlying the speaker grille such that it would be between the speaker grille and the speaker housing when the grille assembly is installed on the speaker housing. The foam and/or cloth layer should be an “acoustically transparent” material, i.e., having low acoustic impedance, or little or negligible effect on sound or acoustic waves passing through it. Such material(s) may further be chosen and/or configured to obscure the visibility of objects behind it, such as acoustic transducers or other components of the playback device. The layer can include a soft foam or fine woven fabric (e.g., plastic or cloth) with a loose weave that does not significantly affect air pressure, but has a solid enough appearance to prevent “read through” or the ability to see objects that are behind it.

In some cases, at least some components of the grille assembly may be assembled before the grille assembly is installed onto the speaker housing. In other cases, some components of the grille assembly can be assembled via attachments to the speaker housing, rather than being pre-assembled prior to being wholly installed onto the speaker housing. For instance, in some embodiments, at least some of the attachment features are mounted to the speaker housing before the speaker grille. This sequence may have benefits, such as improving fitment and/or alignment of the speaker grille to the speaker housing. In some embodiments, the grille assembly can be removed and reattached as a whole from the speaker housing by reversing securing mechanism(s) of the attachment feature(s).

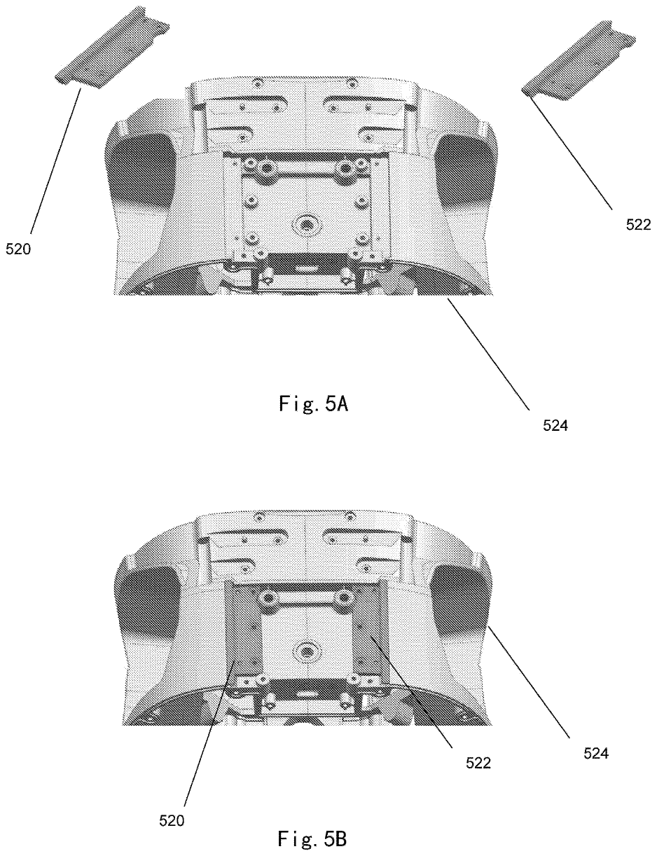

FIGS. 5A and 5B illustrate two frame members 520 and 522 as attachment features that can be mounted onto speaker housing 524. In some cases, as will be described below, the frame members 520 and 522 may be attached onto the speaker housing 524 before the speaker grille is attached to them to create the grille assembly. The frame members 520 and 522 are separate from the speaker housing 524 in FIG. 5A and are mounted to the speaker housing 524 in FIG. 5B. Frame members 520 and 522 may be plastic, or another rigid material such as other types of polymers, and/or metal. The frame members 520 and 522 may be mounted to the speaker housing in any of a variety of ways. In one example, the frame members 520 and 522 have holes as shown in FIGS. 5A and 5B. Accordingly, screws or bolts may then be fastened through the holes of the frame members 520 and 522 into the speaker housing. Remaining components of the grille subassembly (i.e. the grille assembly without the frame members 520 and 522), including the speaker grille and optionally the foam and/or cloth layer(s), can then be attached to the speaker housing 524 via frame members 520 and 522 as their anchor points.

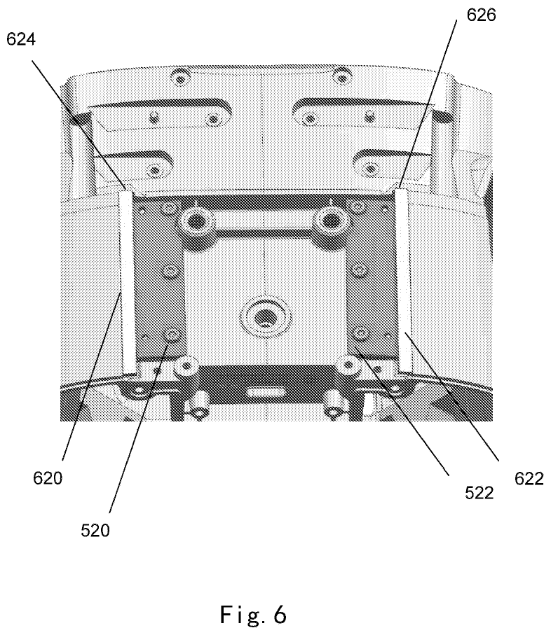

FIG. 6 illustrates adhesives 620 and 622 that are placed on frame members 520 and 522, respectively. Accordingly, the speaker grille and/or other components of the grille subassembly can be mounted onto the speaker housing 524 via the frame members 520 and 522 using the adhesives 620 and 622, by processes such as those discussed further below.

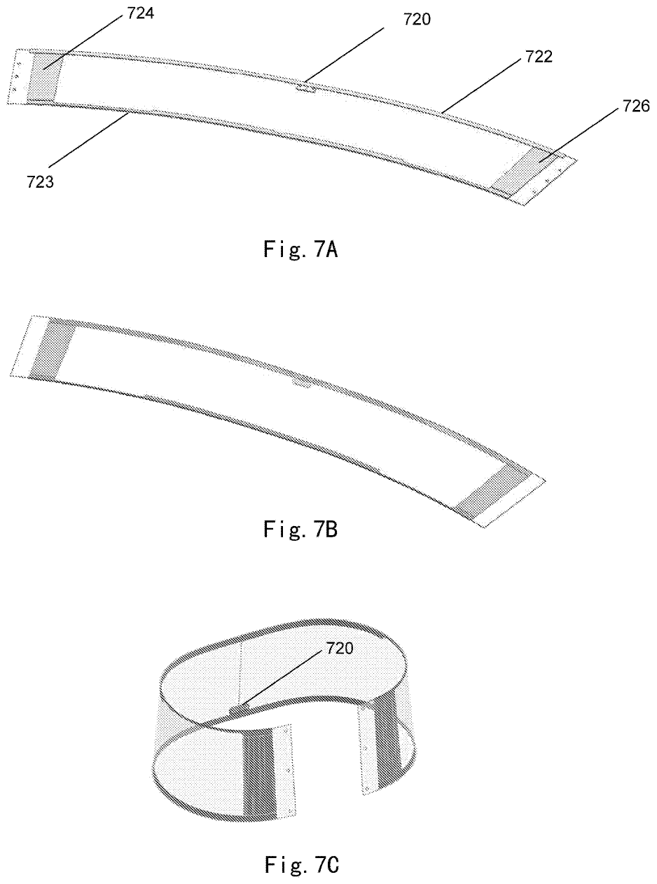

The grille subassembly as separate from the speaker housing 524 is illustrated in FIGS. 7A, 7B, and 7C. FIG. 7A shows a backside of the grille subassembly configured to interface with the speaker housing 524. FIG. 7B shows a frontside of the grille subassembly that may be visible to users of the playback device having the partially curved industrial design. FIG. 7C shows the grille subassembly in a curved shape or configuration such as it could be when mounted onto the speaker housing 524. The grille subassembly may appear similar to that shown in FIG. 7C if it is at least partially pre-curved to at least partially match the curvature(s) of the speaker housing 524, as mentioned previously above.

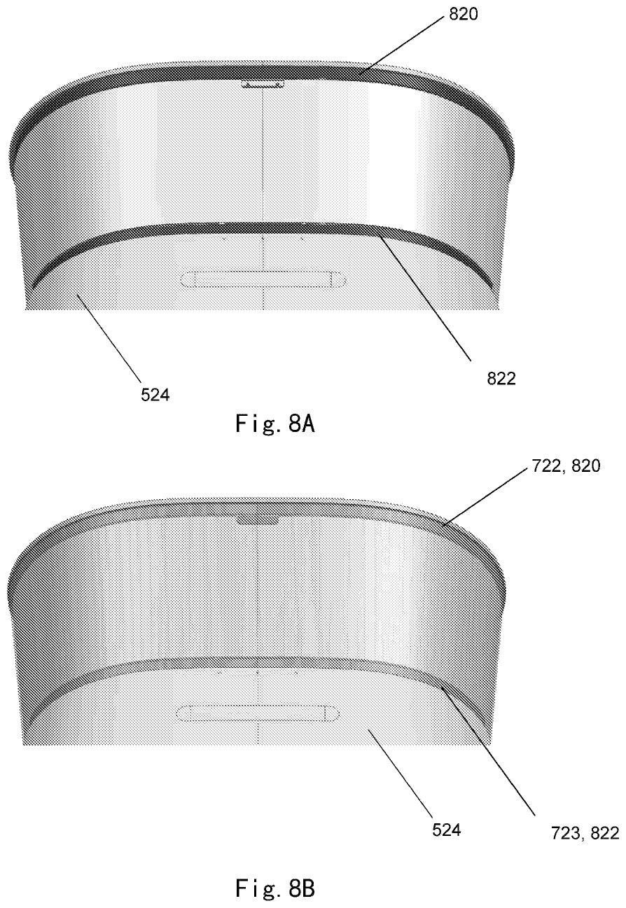

The grille subassembly may include one or more locating pins 720, upper fastener strip 722, lower fastener strip 723, and/or adhesive or adhesive contacting areas 724 and 726. An upper fastener strip 820 and a lower fastener strip 822 on the speaker housing 524, as illustrated in FIG. 8A, may be configured to interface with upper fastener strip 722 and lower fastener strip 723, respectively to secure the associated portions of the grille subassembly to the speaker housing 524. In one example, upper fastener strips 722 and 820, and lower fastener strips 723 and 822 may be complimentary elements of a hook-and-loop fastener. Other types of fasteners that are capable of secure attachment, detachment, and reattachment may also be used. FIG. 8B shows the grille subassembly mounted on the speaker housing with the upper fastener strips 722 and 820, and lower fastener strips 723 and 822, respectively, aligned and secured to each other.

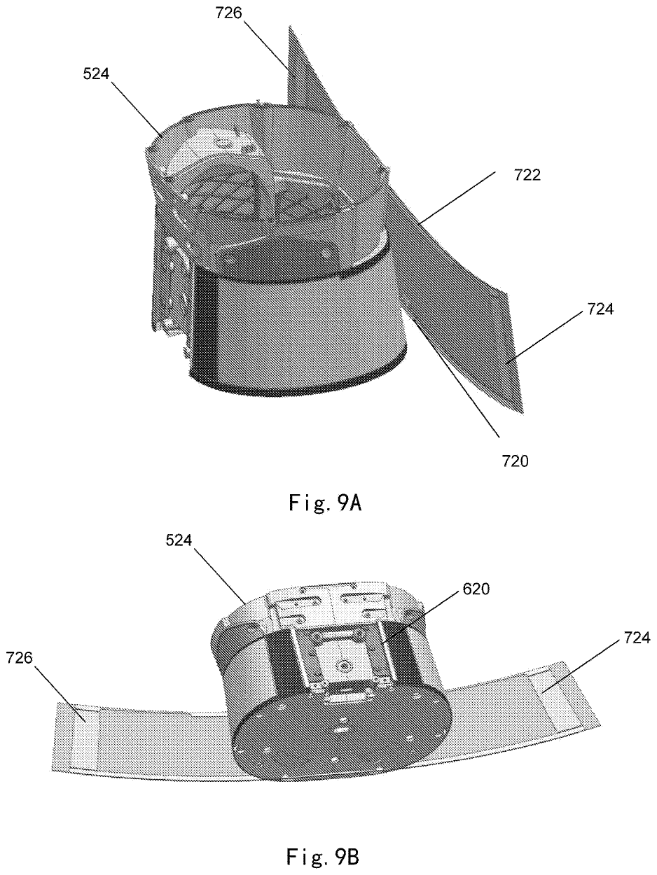

As will be discussed further below, the grille subassembly can be aligned with a speaker housing using the one or more locating pins 720 and wrapped around the speaker housing 524. One such configuration is illustrated in FIGS. 9A and 9B. Locating pins 720 can be inserted into a receiving hole in the speaker housing 524 to anchor and align, i.e. center a portion of the grille subassembly. Processes for manufacturing a curved speaker grille are discussed next.

b. Processes for Manufacturing a Curved Speaker Grille

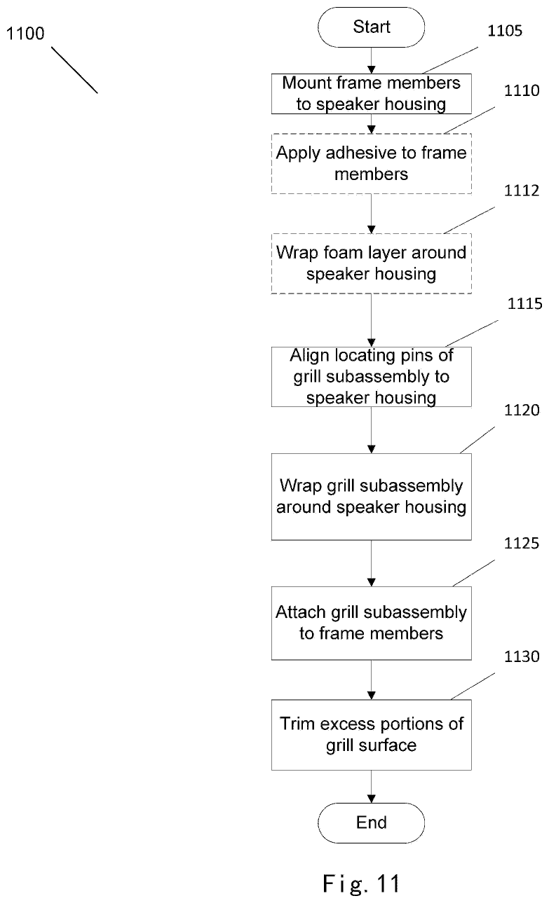

A process for mounting a speaker grille subassembly that includes a flexible speaker grille to a speaker housing in accordance with an embodiment of the invention is illustrated in FIG. 11. The process (1100) includes mounting (1105) frame members 520, 522 to a speaker housing. As described above, a set of components that includes the speaker grille and attachment features (e.g., frame members) for mounting onto a speaker housing can be referred to as a grille assembly. A set of components of the grille assembly without the frame members may be referred to as the grille subassembly. Frame members 520 and 522 are illustrated as separate from speaker housing 524 in FIG. 5A, and illustrated as attached to the speaker housing 524 in FIG. 5B.

Frame members can be plastic, or another rigid material such as other types of polymers, and/or metal. The frame members 520 and 522 may be mounted to the speaker housing 524 in any of a variety of ways. In some embodiments, the frame members 520 and 522 have holes through which screws or bolts may be fastened into the speaker housing. Remaining components of the grille assembly (“grille subassembly”), including the speaker grille and optionally a foam and/or cloth layer, can then be attached to the speaker housing 524 via frame members 520 and 522 as their anchor points.

Adhesive is applied (1110) to portions of the outer surface of the frame members 520 and 522 that face away from the speaker housing 524. In some embodiments, the adhesive can be applied first to the frame members 520 and 522, before attaching the grille assembly to the frame members 520 and 522. Alternatively, in other embodiments, the adhesive can be applied first to the grille subassembly, before attaching the grille subassembly to the frame members 520 and 522. The adhesive can be, for example, heat sensitive adhesives (HSA) or pressure sensitive adhesives (PSA). Other types of adhesives such as liquid glue, which may be brushed or sprayed on, are also possible. FIG. 6 illustrates adhesive 620 and 622 applied to outer surfaces 624 and 626 of frame members 520 and 522, respectively.

Further, as illustrated in FIGS. 7A, 7B, and 7C, and FIGS. 8A and 8B, and discussed above, at least some portions of the fastener strips 722 and 723 may be attached to the upper and lower edges of the grille subassembly, and at least some portions of the corresponding fastener strips 820 and 822 may be attached to the speaker housing 524 along where the upper and lower edges, respectively, of the grille subassembly are to be aligned. Fastener strips 722 and 723 may be attached to components of the grille subassembly (speaker grille and/or foam and/or cloth layer) using adhesives. Likewise, fastener strips 820 and 822 may also be attached to the speaker housing 524 using adhesives. As described earlier, the adhesives may include one or more of heat sensitive adhesives (HSA), pressure sensitive adhesives (PSA), or other types of adhesives such as liquid glue.

As mentioned previously, the grille subassembly may further include a foam or cloth layer positioned underneath the speaker grille and on the inner, speaker housing-side of the grille assembly when attached. In some cases, the foam or cloth later may be aligned and attached to the underside of the speaker grille prior to wrapping and attaching the grille subassembly to the speaker housing 524. In other cases, the foam layer can be wrapped (1112) around the speaker housing before the remaining components of the grille subassembly are attached. As previously discussed, the foam or cloth layer should be an “acoustically transparent” material, i.e., having low acoustic impedance, or little or negligible effect on sound or acoustic waves passing through it. Such material(s) may further be chosen and/or configured to obscure the visibility of objects behind it, such as acoustic transducers or other components of the playback device. The layer can include a soft foam or fine woven fabric (e.g., plastic or cloth) with a loose weave that does not significantly affect air pressure, but has a solid enough appearance to prevent “read through” or the ability to see objects that are behind it.

The process (1100) further includes steps for attaching the grille subassembly to the speaker housing. The grille subassembly is illustrated separate from a speaker housing 524 in FIGS. 7A, 7B, and 7C. As shown, the grille subassembly includes locating pins 720, fasteners 722 and 723, and adhesive or adhesive contacting areas 724 and 726.

Attaching the grille subassembly to the speaker housing 524 can include aligning (1115) the grille subassembly to the speaker housing 524 using the locating pins 720 on the grille subassembly. The grille subassembly aligned with a speaker housing 524 is illustrated in FIGS. 9A and 9B. Locating pins 720 may protrude out of the lower/inner surface of the grille subassembly that faces the speaker housing. The locating pins 720 can be aligned with and inserted into corresponding receiving holes in the speaker housing 524. In one example, the one or more locating pins 720 are located on or near a center line that bisects the grille surface, and the corresponding receiving holes are located on or near a corresponding centerline of the speaker housing 524. In another example, one or more locating pins 720 may be located along various parts of the grille subassembly and configured to be inserted into corresponding receiving holes on the speaker housing 524.

The process (1100) includes wrapping (1120) the grille subassembly around the speaker housing 524. As such, the grille subassembly is bent/curved to conform to the shape of the speaker housing 524. As mentioned previously, in some cases the grille subassembly may be at least partially pre-curved. In one example, pre-curving of the grille subassembly may involve using a curved frame that at least partially matches the curvature of the speaker housing. The speaker grille and/or underlying foam layer may be adhered to the curved frame. In some cases, the fastener strips 722 and 723 and/or the locating pins 720 may be part of the curved frame. In another example, pre-curving of the grille subassembly may involve thermoforming the speaker grille. For instance, heat may be applied the speaker grille while the speaker grille (or speaker subassembly) is wrapped around a structure that at least partially mimics the curvature of the speaker housing. In some cases, the structure may be a heating source contributing to the thermoforming process.

Referring back to the process (1100), portions of one side of the fasteners (e.g., hook side of a hook and loop fastener) on the grille subassembly (722, 723) are mated to portions of a complementary side of the fasteners (e.g., loop side of the hook and loop fastener) on the speaker housing 524 (820, 822) to fasten the grille subassembly onto the speaker housing 524. To ensure a tight and properly aligned fit of the grille subassembly around the speaker housing 524, a roller-type device or machinery may be used to firmly press the grille subassembly around the speaker housing 524. The roller-type device may begin near the centerline of the speaker housing 524 and sequentially or concurrently roll and press the grille subassembly around the speaker housing 524 towards where the frame members 520 and 522 are positioned on the substantially opposite side of the speaker housing 524. Additional pressing of the grille subassembly may be performed to further ensure that the fasteners, such as hook and loop fasteners (722, 723, 820, 822), are securely attached, and accordingly ensure that the grille subassembly is securely attached to the speaker housing 524.

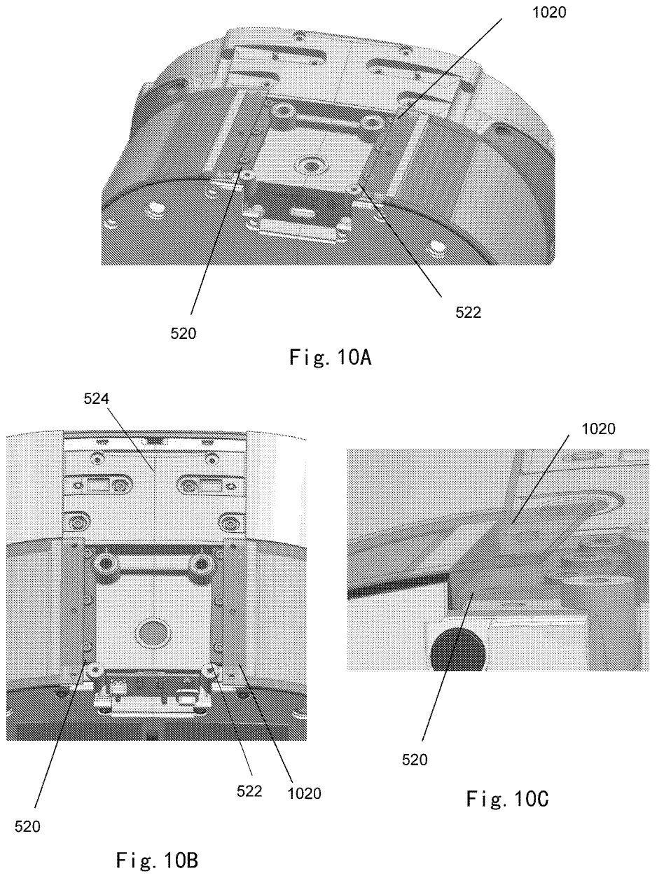

The process (1100) includes attaching (1125) the adhesive contacting areas 724 and 726 of the grille subassembly to the adhesives 620 and 622 on the outer surfaces of the frame members 520 and 522. As mentioned further above, the adhesives 620 and 622 may be first placed on the frame members 520 and 522 or first placed on the grille subassembly. FIGS. 10A, 10B, and 10C illustrate the grille subassembly attached to frame members 520 and 522 via the locating pins 720, fasteners 722, 723, 820, 822, and adhesives 620, 622, as described above. As previously described, the frame members 520 and 522 were already attached to the speaker housing 524.

In some cases, further pressing of the grille subassembly, in particular along the locations of the adhesive contacting areas 724 and 726 may be performed to ensure the adhesive contacting areas 724 and 726 are securely attached to the adhesives 620 and 622 of the frame members 520 and 522. In some cases, heat may be applied during the pressing of the grille subassembly against the speaker housing 524 if the adhesive(s) used in any of the attachment points include heat sensitive adhesives.

In some examples, pressing of the grille subassembly against the speaker housing 524 (with or without heat) may be performed at every intermediate step where alignment or attachment takes place. In other examples, a single pressing of the grille subassembly against the speaker housing 524 (with or without heat) may be performed after two or more intermediate steps. For instance, after rolling of the grille subassembly to ensure proper fit and alignment, a single pressing of the grille subassembly against the speaker housing 524 (with or without heat) may be performed to ensure secure attachment via both the fasteners 722, 723, 820, 822, as well as the adhesives 620 and 622.

Once the grille subassembly is attached to the speaker housing 524, some material of the speaker grille (and/or the underlying foam and/or cloth layer) may protrude beyond the portions that are secured to frame members 520 and 522 by adhesives 620 and 622. As illustrated in FIGS. 10A, 10B, and 10C, the protruding material 1020 can be seen as extending beyond the adjacent surfaces of the frame members 520 and 522. The protruding material can be trimmed (1130) by cutting so that the edges of the material are flush with the edges of the frame members 520 and 522. The trimming of the protruding material may be performed for better aesthetic appearance and/or to reduce interference with adjacent surfaces.

In some embodiments, the frame members 520 and 522 can be removed from the speaker housing before the protruding material is trimmed by, e.g., removing the screws or bolts securing the frame members to the speaker housing. In other embodiments, the excess material can be trimmed without removing the frame members 520 and 522. In some cases, a cover element may further be attached onto the speaker housing 524 to obscure the frame elements 520 and 522 and portions of the grille assembly from view, thereby providing a preferred aesthetic of the playback device.

As indicated previously, removal of the grille assembly may be necessary (or at least helpful) for certain maintenance, repairs, or adjustments of the playback device. A grille assembly as described herein is conducive to removal because it can be wholly removed by detaching (e.g. unscrewing) the frame elements 520 and 522 from the speaker housing 524 (after removal of the cover element if there is one), and detaching the fasteners 722 and 723 on the grille assembly from the fasteners 820 and 822, respectively, on the speaker housing 524. In the case the fasteners are hook-and-loop type fasteners, detachment may involve simply pulling the two sides apart.

Moreover, the grille assembly may then be reinstalled by aligning the grille assembly with the speaker housing 524 and re-attaching the frame elements 520 and 522 to the speaker housing 524. Because the grille assembly was assembled and aligned while at least some of the components of the grille assembly were attached to the speaker housing 524, proper alignment of the grille assembly with the speaker housing 524 during re-installment will be easier.

Although a process for manufacturing a speaker grille in accordance with an embodiment of the invention is described above with reference to FIG. 11, one skilled in the art will recognize that other processes for manufacturing a speaker grille that add, remove, combine, and/or reorder steps in the above described process are possible without departing from embodiments of this invention.

### IV. Conclusion

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only way(s) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the forgoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

1. A method for mounting a flexible speaker grille onto an audio speaker housing, the method comprising:
mounting two plastic frame members to a speaker housing by one or more screws into threaded holes in the speaker housing;
applying adhesive to the outer surface of each of the two frame members;
aligning one or more locating pins of a grille subassembly to corresponding one or more receiving holes a speaker housing, wherein the grille subassembly comprises:
a grille surface comprising a thin, flat piece of plastic having holes through it;
strips of one side of a hook-and-loop fastener attached across each of the four edges of the grille surface;
the one or more locating pins near the midpoint of one of the long edges of the grille surface;
wrapping the grille subassembly around the speaker housing such that the grille subassembly conforms to the adjacent surface of the speaker housing and attaching the strips of hook-and-loop faster to a complementary side of hook-and-loop fastener located on the speaker housing; and
attaching each distant edge of the grille subassembly to the adhesive on the outer surface of each of the two frame members.

2. The method of claim 1, wherein the piece of plastic is trapezoidal.

3. The method of claim 1, wherein the frame members are hard plastic.

4. The method of claim 1 further comprising:
trimming excess portions of the grille surface that extend beyond adjacent portions of the frame members.

5. The method of claim 1, wherein the adhesive is heat sensitive adhesive (HSA).

6. The method of claim 1, wherein the adhesive is pressure sensitive adhesive (PSA).

7. The method of claim 1, further comprising attaching a back cover to the speaker housing over the frame members.

8. The method of claim 1, further comprising wrapping a thin foam layer around the speaker housing before wrapping the grille subassembly around the speaker housing.

9. The method of claim 1, further comprising removing the two frame members from the speaker housing before trimming excess portions of the grille surface and remounting the two frame members to the speaker housing after trimming excess portions of the grille surface.

10. The method of claim 1, wherein the radius of the speaker housing is different across the width of the shorter dimension of the grille surface.

11. An audio speaker with a flexible speaker grille attached, comprising:
an audio speaker housing;
a grille assembly wrapped around at least part of the audio speaker housing, the grille assembly comprising:
a grille surface comprising a thin, flat piece of plastic having holes through it;
strips of one side of a hook-and-loop fastener attached across each of the four edges of the grille surface;
the one or more locating pins near the midpoint of one of the long edges of the grille surface;
wherein the grille subassembly is wrapped around at least part of the audio speaker housing by:
mounting two plastic frame members to a speaker housing by one or more screws into threaded holes in the speaker housing;
wrapping the grille subassembly around the speaker housing such that the grille subassembly conforms to the adjacent surface of the speaker housing and attaching the strips of hook-and-loop faster to a complementary side of hook-and-loop fastener located on the speaker housing; and
attaching each distant edge of the grille subassembly to the adhesive on the outer surface of each of the two frame members.

12. The audio speaker of claim 11, wherein the piece of plastic is trapezoidal.

13. The audio speaker of claim 11 of claim 1, wherein the frame members are hard plastic.

14. The audio speaker of claim 11 wherein wrapping the grille subassembly around at least part of the audio speaker further comprises:
trimming excess portions of the grille surface that extend beyond adjacent portions of the frame members.

15. The audio speaker of claim 11, wherein the adhesive is heat sensitive adhesive (HSA).

16. The audio speaker of claim 11, wherein the adhesive is pressure sensitive adhesive (PSA).

17. The audio speaker of claim 11, wherein wrapping the grille subassembly around at least part of the audio speaker further comprises:
attaching a back cover to the speaker housing over the frame members.

18. The audio speaker of claim 11, wherein wrapping the grille subassembly around at least part of the audio speaker further comprises:
wrapping a thin foam layer around the speaker housing before wrapping the grille subassembly around the speaker housing.

19. The audio speaker of claim 11, wherein wrapping the grille subassembly around at least part of the audio speaker further comprises:
removing the two frame members from the speaker housing before trimming excess portions of the grille surface and remounting the two frame members to the speaker housing after trimming excess portions of the grille surface.

20. The audio speaker of claim 11, wherein the radius of the speaker housing is different across the width of the shorter dimension of the grille surface.
